(19) United States
(12) Patent Application Publication
(10) Pub. No.: US 2016/0055458 A1
(43) Pub. Date: Feb. 25, 2016

(54) Method for Creating Insight Reports

(71) Applicant: Michael Bruce, New York, NY (US)

(72) Inventor: Michael Bruce, New York, NY (US)

(21) Appl. No.: 14/839,936

(22) Filed: Aug. 29, 2015

Related U.S. Application Data
(63) Continuation-in-part of application No. 13/196,736, filed on Aug. 2, 2011, now abandoned.

(51) Int. Cl. G06Q 10/10; G06Q 10/06

(52) U.S. Cl. CPC G06Q 10/1053; G06Q 10/063

(57) ABSTRACT

The present invention generally concerns a method for creating an insight report to recruit for a job opening. More specifically, the method includes an organization administering a two part survey to their employees. Questions from Part A are a pretext to measure the use of employee Attributes at their current job against a comparable job held with a previous employer, where these Attributes are recognized and valued by an organization. In Part B the respondent is given the opportunity to see the Attributes culled from Part A and detail how the organization values these Attributes and how they're allowed to manifest them. The survey answers are used to create an insight report that gives an organization deeper understanding of job distinctions at work group levels. The insight report is also used to craft job advertisements that reflect organizational Attributes having the greatest distinctions.

### RELATED APPLICATIONS

This application claims priority to U.S. patent application Ser. No. 13/196,736 filed on Aug. 2, 2011, which is hereby abandoned.

### FIELD OF THE INVENTION

The present invention generally concerns a method for creating an insight report to recruit for a job opening. More specifically, the method includes an organization administering a two part survey to their employees. Questions from Part A are a pretext to measure the use of employee Attributes at their current job against a comparable job held with a previous employer, where these Attributes are recognized and valued by the organization. In Part B the respondent is given the opportunity to see the Attributes culled from Part A and detail how the organization values these Attributes and how they're allowed to manifest them. The survey answers are used to create an insight report that gives an organization deeper understanding of job distinctions at work group levels. The insight report is also used to craft job advertisements that reflect organizational Attributes having the greatest distinctions.

### BACKGROUND OF THE INVENTION

What distinguishes an employer and any of its workgroups at the job environment level from its competitors, and how can the organization effectively communicate these distinctions in its job environments over other organizations?

Organizations need better tools to help them attract top candidates who have a greater chance of being fulfilled in their jobs. A recent report on leading a multigenerational workforce indicates: (1) competition for talent is escalating; (2) more generations are working side-by-side; and (3) productivity and business results are linked to work environment. Whether it is due to the needs of a diverse workforce or current competitive trends, now more than ever, people feel empowered to use their personal Attributes to succeed in the work place.

When recruiting, most organizations look for similar qualities in their employees, and these days, savvy organizations are developing employer brands that communicate values and principles that they think are sought by job seekers. These organizations sincerely want to address what they think people want from an employer. Traditional methods give the potential employer little to no distinction relative to its competitors when advertising a particular job opening, and traditional advertising scripts do not account for Attributes that are not inherent in the job title or description.

Creating ads for job vacancies is a skill that requires insight into both the work culture of the organization filling the job and the specific job culture and principles prioritized, but are unspoken, by their target audience. In striking this balance, organizations need to effectively communicate their purpose to their audience by carefully selecting language and images that build and protect their brand but also manages to make themselves distinct over their competitors by appealing to a job seeker's distinct qualities.

Distinctions relative to competitors, as well as distinctions among job environments within one organization, always exist. By understanding and embracing its unique characteristics, an organization creates the opportunity to build a workforce that values what it has to offer. Most writers fail to gain the perspective of current employees holding a similar job within the organization listing the vacancy. Surveying an employee on their use of distinctive qualities during the course of their workday to describe a job gives the writer insight into Attributes that distinguishes an organization's work culture with language not inherent in a generic job title or description.

When employees from different departments take the survey and if those employees have worked in a similar capacity in other organizations, mathematical weights are given to their answers. Since all the questions for the organization giving the survey are mostly the same, the present invention can determine which weighted Attribute is distinctive for different departments, or geographies, performance levels, and the like within the organization. The weighted answers for the survey questions can be analyzed for the importance of distinct Attributes based on an employee's ethnicity, age, office location, performance level, tenure, etc. within an organization, giving the organization a deeper insight into its workforce environment.

U.S. Pat. No. 7,606,778 to K. Dewar discloses a system for assessing the suitability of job applicants for an employer.

U.S. Pat. No. 8,200,584 to C. E. Brickman, Jr. discloses a system for advertising an employment opportunity that efficiently provides information needed to a prospective employee to make holistic assessments of job opportunities.

U.S. Pat. No. 7,233,971 to R. Levy discloses a system and method for analyzing work activity and valuing human capital.

The present invention provides an organization with an accurate picture of its job environment and the distinctive Attributes used by their employees during the course of their work day. Analyzing this information uncovers the common distinctive traits between departments in an organization and its employees. If those job nuances were used to attract “right-fit” candidates, these companies would realize fewer turnovers. None of the cited references disclose or claim analyzing distinctions in the use Attributes valued by an organization or employees for a job against a previously held position in another organization to create an insight report and advertising scripts. Therefore, there is a need for this invention.

### SUMMARY OF THE INVENTION

Embodiments of the present invention address these problems by presenting a method for creating an insight report to generate advertising scripts and measure job distinctions within an organization including the steps of administering a two part survey to a respondent, Parts A and B, that measure and describe distinct Attributes used in their current job against a similar job held with a previous employer. Each question for Part A is a pretext to measure the use of distinctive Attributes in a job within the current organization, and the respondent answers each question with a weighted response choice, once for the current organization and again for the previous organization. The program takes differences between the weighted response choices and reveals the Attributes with the greatest distinction on either side of the curve selected from Part A to the respondent. In Part B, the respondent answers a series of open ended questions regarding the Attributes selected in Part A and personal Attributes used at both the current job and previous job, the data from Part A and Part B are aggregated and analyzed into an insight report that finds language for eventual advertising scripts and provides the organization with distinctions in their jobs over other organizations.

It is an embodiment of the present invention where the respondent has been resident in a job with a current organization for at least four months and has held a similar position with a previous employer.

It is an embodiment of the present invention wherein a distinct Attribute is a numerical difference between weights on pretexted questions that measures an employee's use of an Attribute in a current job against a similar job held with a previous employer.

It is an embodiment of the present invention where Attributes refer to unspoken qualities or characteristics that the organization values, recognizes, and rewards or that the respondent personally uses during the course of their work day to do their job, or any combinations thereof.

It is an embodiment of the present invention where the insight report is an aggregation on the distinctions for Attributes selected from Part A and at least one personal Attribute from respondent in Part B with exposition on the use and importance of the same.

It is an embodiment of the present invention where the insight report includes a Job Quotient, Organizational Quotient, Job Differentiators, The Employee's Valued Attribute, and The Unique Recruitment Proposition that divulges to an organization key distinctions in the use of Attributes in the current job with the current organization, key distinctions in the use of Attributes in the previous job with the previous organization, an Attribute the employee values in themselves, how an employee's uses Attributes favored by the current organization, how distinctions in the use of Attributes vary across jobs and workgroups, and which types of employees use which Attributes.

It is an embodiment of the present invention where a computing system generates an insight report for finding distinctions in the use of Attributes valued by an organization against a previous organization or an employee to create advertising scripts that includes one computer readable medium having a plurality of Attributes valued by an organization, plurality of data regarding Attributes in relation to a first organization against a relation to other organizations, and program for taking differences, means, and, standard deviations to analyze distinctions between numerical weights on response choices between a current organization against a previous organization, and entry GUIs to allow a respondent to give exposition on hidden Attributes, Attributes valued by the organization, and Attributes they personally value.

It is an embodiment of the present invention where an industrial organization psychologist analyzes the results of Parts A and B to find language that creates the insight report.

### BRIEF DESCRIPTION OF DRAWINGS

FIG. 1 is a diagram of an exemplary Network configuration for operating the disclosed invention.

FIG. 2 is an exemplary survey in accordance with aspects of the disclosed invention. For each question in Part A, a respondent must answer the question twice with fixed answers, the first time rating the question relative to their current job and again for how the question relates to their previous job experience with another organization. The respondent neither sees nor has knowledge of the organization's measuring of Attribute(s) represented by each question.

FIG. 3 is an exemplary table showing respondent questions, hidden pretexted Attributes, and bar analysis of respondent answers, showing which Attributes relate to the subject organization more than other organizations and showing which Attributes relate to previous organizations more than the current organization.

FIG. 4 is an exemplary table showing nine respondent choices for returned weights concerning Question 7 of FIG. 3. Answers reflect how a particular Attribute for Question 7 is used more at the current job against a previous job held with another organization, i.e. a response choice returning a positive difference.

FIG. 5 is an exemplary table showing nine respondent choices for returned weights concerning Question 7 of FIG. 3. Answers reflect how a particular Attribute for Question 7 was used more at a similar job with a previous organization against the current job and organization, i.e. a response choice returning a negative difference.

FIG. 6a depicts a table having responses to the three questions having the highest positive-value differences between average current job responses and average previous job responses, being Questions seven, thirty-three, and eleven from FIG. 3.

FIG. 6b depicts a table having responses to the three questions having the lowest negative-value differences between average current job responses and average previous job responses, being Questions seventeen, thirty three, and nine from FIG. 3.

FIG. 7a depicts a table showing the respondents having the most relevant response for the mean average for the most positive distinctions in Attributes.

FIG. 7b depicts a table showing the respondents having the most relevant response for the mean average for the most negative distinctions in Attributes.

FIG. 8 is an input field of an exemplary interface for a respondent to enter insightful responses in Part B concerning Attributes valued by both the organization and the respondent.

### DETAILED DESCRIPTION OF THE INVENTION

### Definitions

To detail the present invention, the following non-limiting terms are used:

The term “Attribute(s)” generally refers to unspoken qualities or characteristics that an employee uses during the course of their work day to ensure success with their job. Organizations value, honor, and allow employees to exercise these Attributes during the normal course of their job. Attributes may include without limitation Advancement, Autonomy, Collaboration, Detail Orientation, Hierarchy, Initiative, Innovation, Outspoken, Perfectionist, Production Focused, Resourceful, Structure, Visionary, Work/Life Balance, Ambition, Cautious, or Compliant. An organization uses questions from survey Part A as pretexts to measure the difference in use of these Attributes in an employee's current job against a previously held job with another organization.

The term “Advancement” generally refers to an Attribute by which an organization reveres an employee that cherishes the responsibilities and the consequential risks and rewards of taking the next steps to be promoted within an organization.

The term “Ambition” generally refers to an Attribute by which an organization reveres an employee that displays the initiative to advance beyond the normal framework of the promotion process.

The term “Autonomy” generally refers to an Attribute by which an organization reveres an employee that makes decisions with little to no micro managing in solving challenges related to his or her job, where the employee can work without fear or doubt when solving challenges.

The term “Cautious” generally refers to an Attribute by which an organization reveres an employee that heavily includes the fear of failure in their decision making process.

The term “Collaboration” generally refers to an Attribute by which an organization reveres an employee that has the ability to cooperate and work with others. Where the employee shares their ideas with colleagues and is willing to accept the colleague's contribution as well.

The term “Compliant” generally refers to an Attribute by which an organization reveres an employee that understands the importance of addressing issues at the appropriate time.

The term “Detail Orientation” generally refers to an Attribute by which an organization reveres an employee that focuses on the details of a project. Rather than merely looking at the big picture, this employee is disciplined enough to explore the small elements of the task.

The term “Entrepreneurial” generally refers to an Attribute by which an organization reveres an employee that has the insight to invest their own resources to accomplish organizational goals.

The term “Hierarchy” generally refers to an Attribute by which an organization reveres an employee that respects and adheres to a given chain of command without questioning authority.

The term “Initiative” generally refers to an Attribute by which an organization reveres an employee that is described as a person who introduces and takes action upon new ideas or suggestions within an organization.

The term “Innovation” generally refers to an Attribute by which an organization reveres an employee that embraces opportunities to show creativity in trying new things and/or new methods within the organization.

The term “Outspoken” generally refers to an Attribute by which an organization reveres an employee that has the ability to voice their opinion without being restricted by fear.

The term “Perfectionist” generally refers to an Attribute by which an organization reveres an employee that believes that there is no room for error for a given task undertaken within the organization.

The term “Production Focused” generally refers to an Attribute by which an organization reveres an employee that believes getting a product or task completed that meets some basic quality standards is better than futzing with it until it's perfect and missing the bigger picture or missing the deadline.

The term “Resourceful” generally refers to an Attribute by which an organization reveres an employee that harnesses available assets to bring a situation to the desired goal.

The term “Structure” generally means an Attribute by which an organization reveres an employee that works best with a roadmap to solve problems.

The term “Visionary” generally refers to an Attribute by which an organization reveres an employee that has the imagination to see things that are not present in the current reality. They can see possibilities as real probabilities if the right action is taken.

The term “Work/Life Balance” generally refers to an Attribute by which an organization reveres an employee that understands moderation and attempts to honor the balance between achievement and enjoyment.

The term “distinction(s)” or “distinct Attribute” generally refers to a numerical difference between weights on pretexted questions that measures an employee's use of an Attribute in a current job against a similar job held with a previous employer.

### The Embodiment

From this point forward, the following words will describe a method and system that uses survey results to create an insight report on job distinctions within an organization. The present invention includes an organization giving a two part survey to at least one current employee. The results from each portion of the survey, Parts A and B, can be aggregated to create an insight report for the organization. The insight report can reveal to an employer unknown differences in their job culture to better attract “right fit” candidates to open positions. In addition, the survey results are used to guide advertising writers toward language that shows how the organization's job is more distinct over other organization's with similar positions. However, the following words are not a limitation on the scope of the present invention but are written to detail certain embodiments thereof.

Initial Information and Respondents

Initially, the organization renders information, including a previous or current job description, or information on which job Attributes they value, recognize, and reward. This informs what questions to ask in survey Parts A and B. The archived job posting can also be used as a checks and balances for substantive information including but not limited to: education level, experience, and basic skills required by the job. The present invention includes about three to about ten employees taking the survey and returning results. However, this number can include many more employees depending on the size and needs of the organization. Each employee should meet the minimum requirements of having worked in a different organization in a similar capacity and be resident at the current job and organization for at least four months.

The Method by Paper or Computer

The present invention includes a method to create insight reports and job advertisements by measuring the use of employee Attributes in current versus past jobs with another organization. It is an embodiment of the invention where every step, from gathering respondent information and survey answers to analysis of the numerical data, can be done via paper forms to generate the insight reports and job advertisements. However, the use of computers, a Network, databases, and programs are better tools to facilitate and accomplish the end results.

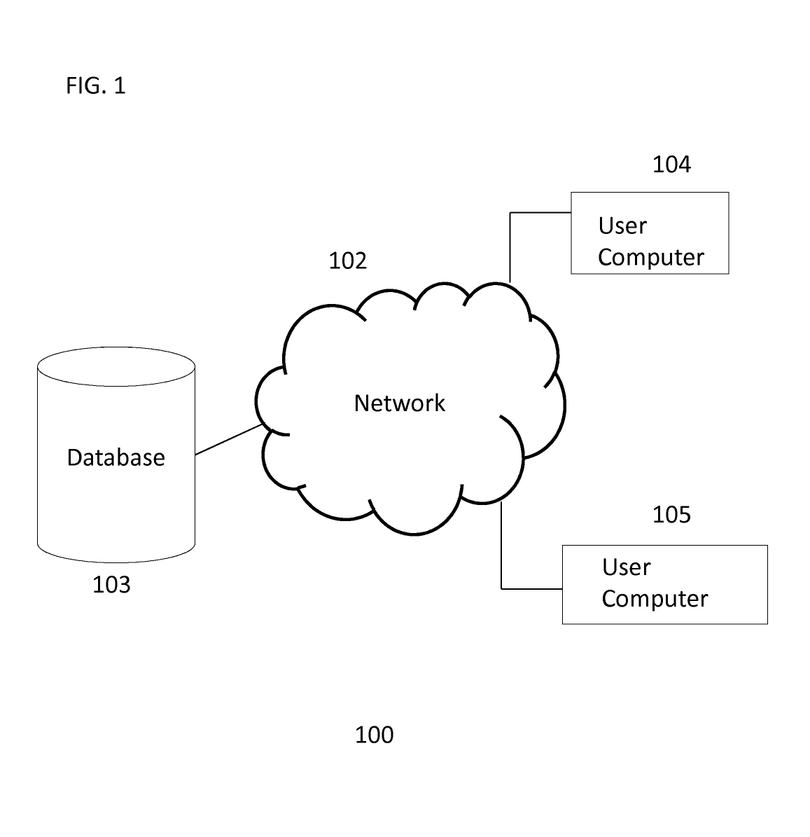

The paper method is fine, but FIG. 1 is a better tool for practicing the present invention. FIG. 1 depicts a computer configuration 100 that includes a Network 102, at least one database 103 and one or more user computers 104, 105, in which the user computers 104, 105 and the at least one database 103 can communicate via the Network 102.

The Network 102 can include part or all of one or more types of communication Networks such as, for example, a cable system, cellular telephone system, a telephone network system, a wired and/or wireless local area network, wide area network, or metropolitan area network, and/or any other type of communication network. The Network 102 can include one or more types of communication mediums, including, for example, wireless over the air, coaxial cable, copper twisted wire, and/or fiber optic cable. The Network 102 and the computers 104, 105 in communication with it can employ communication protocols that will be known to those skilled in the art, including, for example, any packet-based communications protocols. The computer configuration 100 is exemplary and does not limit the scope of the disclosed invention.

A program that facilities this method is installed on a desktop, laptop, mobile device, personal computer, a workstation, a minicomputer, a mainframe, a supercomputer, or a web or computer server, network communication devices (for example, routers, hubs, switches), and/or other computing devices, all of which can be located proximate to each other or remote from each other. The program is capable of gathering and analyzing respondent information on the use of employee Attributes in current and past jobs to create an insight report and job advertisements.

Each computer 104, 105 should have at least one or more central processing units, a main memory for storing these programs or data, and a fixed or hard disk drive unit or other forms of storage, which are all coupled by a data bus. The computer should have a basic operating system, such as MS Windows, Linux, Mac OS, or the like. Its memory can contain programs and information, such as web hosting software, and can access at least one information database having gathering programs, analytics programs, presentation GUIs, or the like.

The computer program may reside on, or in, a hard disk or the memory of a user's computer or may be accessible from a remote server over the Network 102. The gathering and analytics program may be scripted to run inside of Microsoft Internet Explorer, Firefox, Netscape, Opera, Safari, or any compatible web browser, where the web browser is capable of rendering DOM, CSS, Javascript, XML, XMLHttp requests, HTML5, PHP, and the like.

The computer 104, 105 typically receives a number of inputs and outputs for communicating information externally. Non-limiting examples of inputs and outputs may include: a keyboard, a mouse, a trackball, a joystick, a touchpad, and/or a microphone, a CRT monitor, and/or an LCD display panel. The computer 104, 105 may include programs that may work in conjunction with the programs at the database, such as operating system software, programming software (such as C++ or Java), and others that will be recognized by those skilled in the art.

The user's computer 104, 105 connects to a database 103 over a Network and is allowed to see graphical information from the databases' 103 computer via web pages through PHP, JavaScript, and other common platforms, where asynchronous background XML data requests are sent to the database 103. The user's web based application and its computer server uses a graphical user interface (GUI) to present the user with the survey tables exposition pop ups stored on the database 103. The user may view the web pages using Internet browsers such as Internet Explorer, Firefox, Netscape Navigator, Opera, Safari, and the like.

The database 103, or server, of the present invention includes a relational database that stores a collection of data on individual tables having at least one column in common. The programs and electronic information about an organization, including surveys, survey responses, and results of statistical computations are stored on at least one database. The gathering program can include routines that present questions and receive responses to and from each respondent regarding an organization.

The database 103 is accessible over a Network 102 and can be kept by a private firm, non-limiting examples being MySQL, Interbase/Firebird, PSQL, IBM, Microsoft/Sybase, Oracle, and the like, where a firm shall have a database administrator or one or more applications developers. The database 103 is associated with at least one module that receives structured requests from the user's computer 104, 105 that extracts raw data from tables and GUIs within the database, and presents the respondent with survey questions for Parts A and B, response choices for Part A with or without answers, screens to input more detailed answers for both Parts, and returns such data to the user's computer server/computer according to the present invention. The program can include computations and formulas that process the questions and responses to provide distinctions in Attributes used by the employee in their current job against a previous job with another organization.

Respondent Information

The respondent is presented with a web menu, which may be HTML or HTTP accessed via a browser. The respondent is prompted to enter a pre-registered user identification and password at a first web menu. This information may be selected by the respondent and is kept private for future access the program. A non-limiting example is an identification and password having a mixture of alphabetical and numerical values ranging from about six characters to about eight characters in length.

After the login screen, the survey respondent is presented with a GUI having a series of input options including but not limited to identifying their first and last name, e-mail address, work phone, home phone, their location if the organization has multiple offices, their position title, such as, without limitation, analyst, manager, associate, vice president, executive, member, partner, pilot, sales representative, or any other position title in the organization. One embodiment of the present invention includes the ability to input, access, and display additional information regarding a respondent, including but not limited to a respondent id number, job division, job level, and job department, among other things. The presentation invention can access and display the survey questions and the respondent's responses for each survey question within a GUI.

The Design of Survey Part A

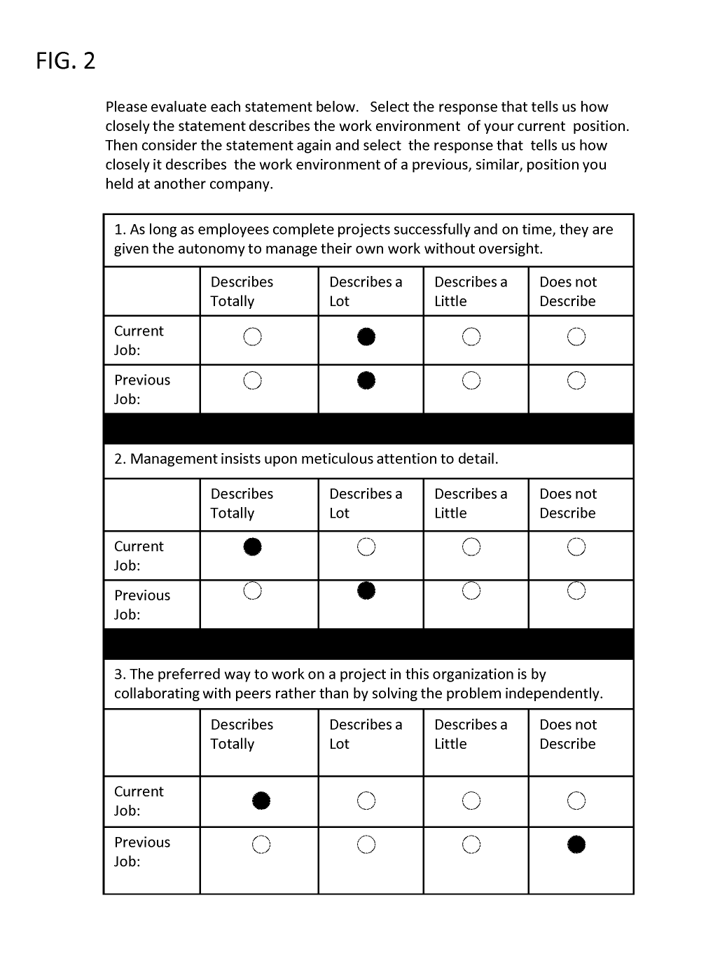

Questions from Part A are a pretext to measure the use of employee Attributes at their current job against a comparable job held with a previous employer, where the organization values and recognizes these Attributes. FIG. 2 depicts a simple GUI presented to a respondent having at least three survey questions. Each question has four response choices, “Describes Totally,” “Describes a Lot,” “Describes a Little,” and “Does not Describe at All.” For each question in Part A, a respondent must answer the question twice with fixed answers, the first time rating the question relative to their current job and again for how the question relates to their previous job experience with another organization. When answering each question, the respondent only sees the question and the four response choices. The respondent neither sees nor has knowledge of the organization's measuring of Attribute(s) represented by each question.

Each response is numerically weighted for both the current and previous job environments with non-limiting numerals including whole numbers, fractions, integers, or any combinations thereof, where the numerical weights are in an assignment table located at a database. The program measures distinctions by taking the difference between the weights associated with each response for the current and previous job. These distinctions are numbers that represent the employee's use of Attributes in the current job against their use in a similar job with a previous organization. One can analyze the previously unknown distinctions in an organization's job culture based on differences between the numbers.

Table 1 gives a non-limiting sample of the questions asked in Part A along with their predetermined, yet hidden, Attributes.

TABLE 1

| Survey Questions Part A | Organizational Attributes |
|---|---|
| Management allows employees to implement outside-of-the-box | Visionary |
| approaches to solve difficult problems. | |
| Employees are given the authority to negotiate customer/vendor | Autonomy |
| arrangements to facilitate better outcomes. | |
| Management insists upon meticulous attention to detail. | Detail Orientation |
| It is acceptable to bypass the established chain of command to solve a | Hierarchy, Outspoken, |
| problem more efficiently. | Initiative, Resourceful |
| Employees are expected to embrace emerging technology. | Innovation |
| It's encouraged to speak out and voice your opinion, even if that | Outspoken |
| opinion goes against the organization's traditional point of view. | |
| Employees are given autonomy to manage their own assignments. | Autonomy |
| Management is always on the prowl for better, more innovative ways | Innovation |
| to accomplish goals. | |
| Employees who show initiative are overtly supported in their efforts. | Initiative |
| Employees who look to move up in the ranks receive career-planning | Ambition |
| assistance within the organization. | |
| Management is open to employees receiving cross-training in other | Advancement |
| areas or specialties of the company. | |
| Opportunity exists to participate in management and decision-making | Collaboration |
| at the firm. | |
| Quotas for billable hours are strictly enforced. | Structure |
| Operating as a lean organization is emphasized. | Resourceful |
| Adequate time is allowed to complete projects to my liking. | Perfectionist |
| When an employee needs help solving a work problem, it's acceptable | Collaboration |
| to go outside the established chain of command for assistance. | |
| Even though quality results are important, getting a solution out on | Production Focused |
| time takes precedence over making it perfect. | |
| Organization often acts upon employee suggestions. | Outspoken, Responsive |
| | Management |
| As long as employees complete projects successfully and on time, they | Autonomy |
| are given the autonomy to manage their own work without oversight. | |
| Opportunities exist to participate in management decisions. | Collaboration |
| Employees who develop new concepts are rewarded for turning their | Innovation with |
| ideas over to their direct supervisors rather than actually presenting | presentation skills |
| those concepts to higher ups themselves. | |
| Even though performance is key for promotion, seniority is what | Seniority Counts |
| frequently tips the scale. | |
| While employees are expected to address customers' current needs, | Visionary, Initiative |
| they are also actively encouraged to anticipate customers' future needs | |
| and desires. | |
| When a challenge arises employees are expected (without being asked) | Initiative |
| to take initiative by suggesting innovative solutions. | |
| Employees are expected to spend time outside of normal office hours | Engaged |
| on work challenges. | |
| The preferred way to work on a project in this organization is by | Collaboration |
| collaborating with peers rather than by solving the problem | |
| independently. | |
| During meetings, it is acceptable to express ideas that are contrary to | Outspoken, Initiative |
| organizational policy. | |
| Employees are constantly encouraged to experiment with new | Innovation, Visionary, |
| solutions and to explore alternatives. | Autonomy |
| Nearly every assignment is loosely defined. | Lack of structure, |
| | Autonomy |
| Winning, being the best and doing better than those around you is the | Competitive |
| way to get ahead here. | |
| Employees have frequent opportunities to learn new technologies and | Innovation |
| develop professional skills. | |
| This organization doesn't mind spending money liberally when | Innovation |
| convinced that it will make a significant difference. | |
| I am encouraged to experiment with new or different methods and | Experimentation, |
| procedures and to explore alternatives. | Innovation |
| The ability to work on your own rather than with others. | Independence, Autonomy |
| You are given autonomy to negotiate terms to facilitate better | Autonomy |
| outcomes. | |
| Sales processes are highly structured. | Structure |
| The ability to identify critical data for program analysis, analyze the | Critical Thinking |
| data and draw meaningful, objective conclusions. | |
| My ideas and recommendations are encouraged and implemented. | Receptive Management, |
| | Outspoken |

Part A: Differences Between Current and Previous Jobs

In Part A, use of Attributes is compared by taking the difference between numerical weights on each response choice selected by the respondent when answering a question. The program can compare the responses regarding the current job and the previous job for any and all questions across all, some, or a single respondent. At a database, the program includes an assignment table having predetermined values for each survey response, where the values decrease in magnitude from the choices “Describe Totally” to “Does Not Describe At All.” Table 2 shows an exemplary assignment table stored at the database having arbitrary weights assigned for each response choice.

TABLE 2

| | Describes | Describes | Describes | Does Not |
|---|---|---|---|---|
| Answer | Totally | a Lot | a Little | Describe |
| Value | 12 | 10 | 7 | 1 |

What follows is a non-limiting code in PHP script. The sample code is pseudo and instructs one in taking the difference between weights associated with each response choice the respondent selects for answering a question twice, one choice for current job and another for the previous job. Note that, common changes, or ones contemplated by one of ordinary skill in the art, are within the scope of the present invention.

Survey = Database.fetch(SurveyID) //fetch survey attributes from the database for the
current survey
Answers = Database.fetch(RespondendID) //fetch answers for a given respondent from
the database
for each Answers as Answer do {//loop over all answers for the current respondent
//calculate the difference using weights for every response option stored when setting
up the survey
Answer.WeightDifference = Survey.AnswerWeights[AnswerCurrentJob] -
Survey.AnswerWeights[Answer.PreviousJob]
print Answer.QuestionID //display the question ID that the current answer belongs to
print Answer.WeightDifference //display the difference
}

In light of changes that can be made to the exemplary code by one of ordinary skill in the art, the present invention includes various schemes to compare, analyze, and extract distinctions in the use of Attributes between the current and previous job. What follows are various ways to take differences and gauge the accuracy of the same between respondent answers for a particular question. However, common changes or ones contemplated by one of ordinary skill in the art are within the scope of the invention.

Part A: Measuring the Difference in Attributes for One Respondent

The program can determine for any particular respondent and any particular question/Attribute, the difference between the value associated with the current job response and the value associated with the previous job response for that question. For a particular respondent, and for each question number, “Q·#”, let Q·#_{VALUE Current Job} denote the value associated with the response to that question regarding the current job, and let Q·#_{VALUE Previous Job} denote the response to that question regarding the previous job. For a respondent, the difference between the value associated with the current job response and the value associated with the previous job is provided by:

Q·#_{VALUE Current Job}−Q·#_{VALUE Previous Job}=Q·#_{DIFFERENCE}.

Using the example assignment from Table 2, the above equation is summarized in Table 3 as follows, with the assumption four questions were answered:

TABLE 3

| | Previous | Describes | Describes | Describe | Does Not |
|---|---|---|---|---|---|
| Difference | Position | Totally | a Lot | a Little | Describe |
| Current Position | Value | 12 | 10 | 7 | 1 |
| | | DIFFERENCE VALUES | | | |
| Describes Totally | 12 | 0 | 2 | 5 | 11 |
| Describes a Lot | 10 | −2 | 0 | 3 | 9 |
| Describe a Little | 7 | −5 | −3 | 0 | 6 |
| Does Not Describe | 1 | −11 | −9 | −6 | 0 |

The Q·#_{DIFFERENCE} values give a magnitude for the Attribute associated with the presented question. The positive-valued differences for an Attribute signifies that the respondent thought that the question described the current job better than it described the previous job, and a negative-valued difference for an Attribute signifies that the respondent thought that the question described the previous job better than it described the current job. Because respondents generally come to the current organization from a variety of different organizations, having a sufficiently large sample size of respondents can give a high confidence in interpreting the differences in an organization compared to its competitors in general. However, one must keep in mind that the true meaning of the differences measures the use of an Attribute at the current job against a previous job held at another organization.

Part A: Finding Attribute Distinctions Through Multiple Respondents

Distinctions in Attributes are realized with the ability to measure and extract average differences for response choices across multiple questions and multiple respondents. Having a greater number of respondents translates into a better defined and insightful number representing a distinction for an Attribute. In one embodiment, the program compares the responses regarding the current job and the responses regarding the previous job for any question across all respondents.

For a question “Q·#” and for a respondent “i”, let VALUE_{current Job, i}, denote the value associated with respondent is answer regarding the current job, and let VALUE_{Previous Job, i}, denote the value associated with respondent i's response regarding the previous job. If there are n respondents, then the average value for responses regarding the current job and the average value for responses regarding the previous job from all n respondents are provided by:

Q·#_{AvgVALUE CurrentJob}=1/nΣ₋(i=0)̂n Value_{current Job,i}

Q·#_{AvgVALUE PreviousJob}=1/nΣ₋(i=0)̂n Value_{Previous Job,i}

A measure of the average response difference for any particular question/Attribute across all respondents can be provided by:

Q·#_{AvgVALUE Current Job}−Q·#_{AvgVALUE Previous Job}=Q·#_{AvgDIFFERENCE}.

Part A finds distinctions in Attributes by surveying multiple respondents across a similar job group within an organization. The respondent should be resident with the current organization for at least four (4) months and have held a similar job with a previous organization. The more questions asked the greater the return of distinguishing Attributes. It is within the scope of the present invention where the number of administered questions in Part A is from about three (3) questions to about 10 questions.

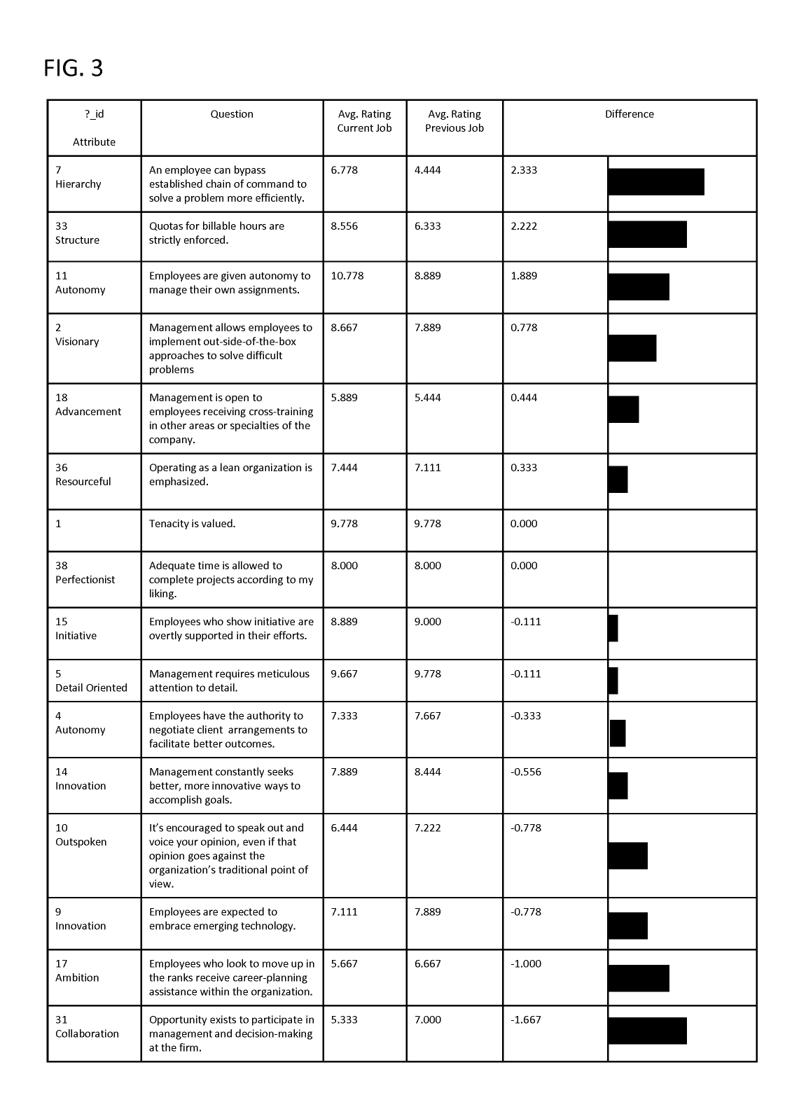

FIG. 3 is a table that shows exemplary results born from computations similar to the above formulas, where numbers for Q·#_{AvgVALUE Current Job}, Q·#_{AvgVALUE Previous Job}, and Q·#_{AvgDIFFERENCE} are generated. In this particular illustration, the table sorts the questions/Attributes by Q·#_{AvgDIFFERENCE}, from the most positive-valued differences to the most negative-valued differences. In this example nine respondents took the survey. Note that, the Attributes are listed under each Question number, but at no time during survey Part A does the respondent see this Attribute.

The positive-valued differences signify that, on average, the respondents thought that the question/Attribute described the current job better than it described the previous job. The negative-valued differences signify, that on average, the respondents thought that the question/Attribute described the previous job better than it described the current job. There need not be inherent judgments accorded to the sign of differences, that is, whether the difference has a positive-value or a negative-value need not be “good” or “bad,” only that the Attribute was used more at the current job or at the previous job with another organization.

Also, an organization need not shy away from the Attributes reflected by negative-valued differences, as these characteristics are also distinctive to the organization and are also important to understand. Because respondents generally come to the current organization from a variety of different organizations, having a sufficiently large sample size of respondents can signify differences in an organization compared to its competitors in general.

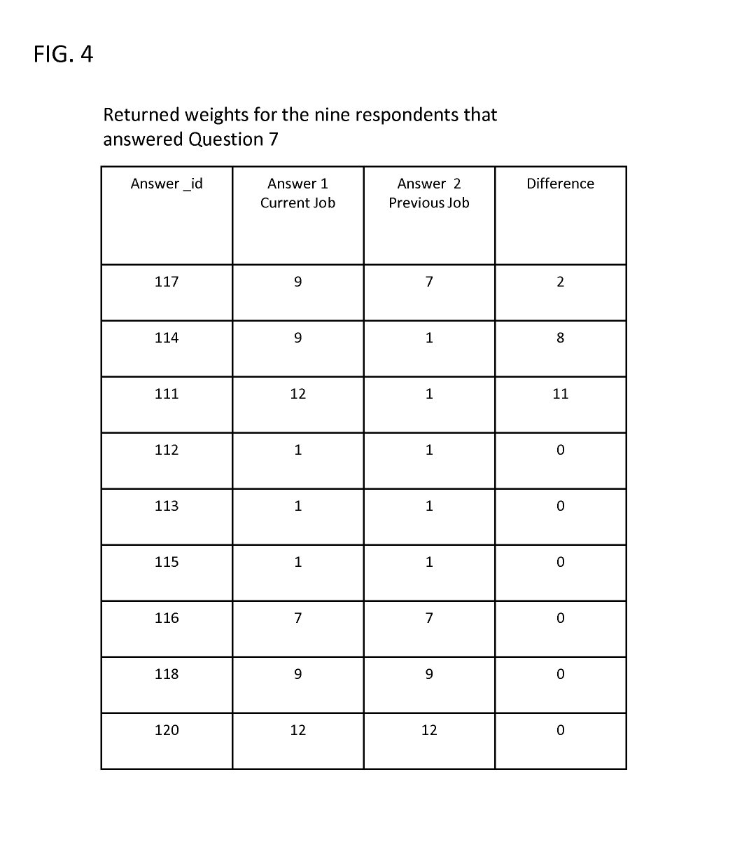

As an example, and with reference to FIG. 4, suppose responses to a particular survey Question 7 in Part A have the associated values shown in FIG. 4. Based on the nine respondents (n=9), the average of the responses regarding the current job would be Q·7_{AvgVALUE Current Job}=6.778, and the average of the responses regarding the previous job would be Q·7_{AvgVALUE Previous Job}=4.444. The distinction, or difference, between the two for Question 7 for question would be Q·7_{AvgDIFFERENCE}=2.333:

Q·x_{AvgVALUE Current Job}−Q·x_{AvgVALUE Previous Job}=Q·x_{AvgDIFFERENCE}6.778−4.444=2.333.

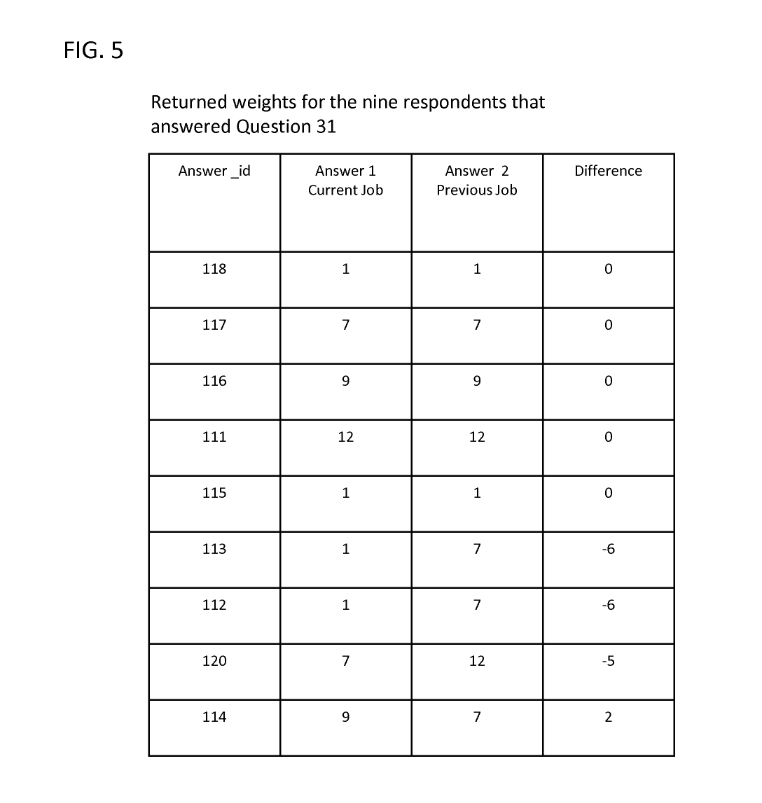

As another example, and with reference to FIG. 5, suppose responses to a particular Question 31 returned those weights. Based on the nine responses (n=9), the average for the responses regarding the current job would be Q·31_{AvgVALUEcurrenJob}=5.333, and the average of the responses regarding the previous job would be Q·31_{AvgVALUEPreviousJob}=7.000. The difference for question 31 would be Q·31_{AvgDIFFERENCE}=−1.667:

Q·y_{AvgVALUE Current Job}−Q·y_{AvgVALUE Previous Job}=Q·y_{AvgDIFFERENCE}5.333−7.000=−1.667.

The program can be defined with the following pseudo code to take the averages of differences between the weights for the response choice for the current job against the previous job across a number of respondents. The program of the present invention uses scripting languages including but not limited to PHP, SQL, and Javascript programming languages. Below is non-limiting example code implemented in PHP. In the illustrated embodiment, the program can generate averages for differences in weights shown in examples FIG. 4 and FIG. 5.

Survey = Database.fetch(SurveyID) //fetch survey attributes from the database for the
current survey
Answers = Database.fetch(QuestionID) //fetch answers for a given question from the
database
TotalDifference = 0 //variable to add up difference
AnswerCount = 0 //variable to count answers
for each Answers as Answer do {//loop over all answers for the current question
//calculate the difference using weights for every response option stored when setting
up the survey
Answer.WeightDifference = Survey.AnswerWeights[AnswerCurrentJob] -
Survey.AnswerWeights[Answer.PreviousJob]
TotalDifference = TotalDifference + Answer.WeightDifference //add the current answer
difference to the cumulative sum
AnswerCount = AnswerCount + 1 //increment number of answers
}//end of loop
print QuestionID //display the question ID
print (TotalDifference/AnswerCount) //display the average as the cumulative sum
divided by the number of answers

Part A: Relevance of Respondents' Difference to the Average

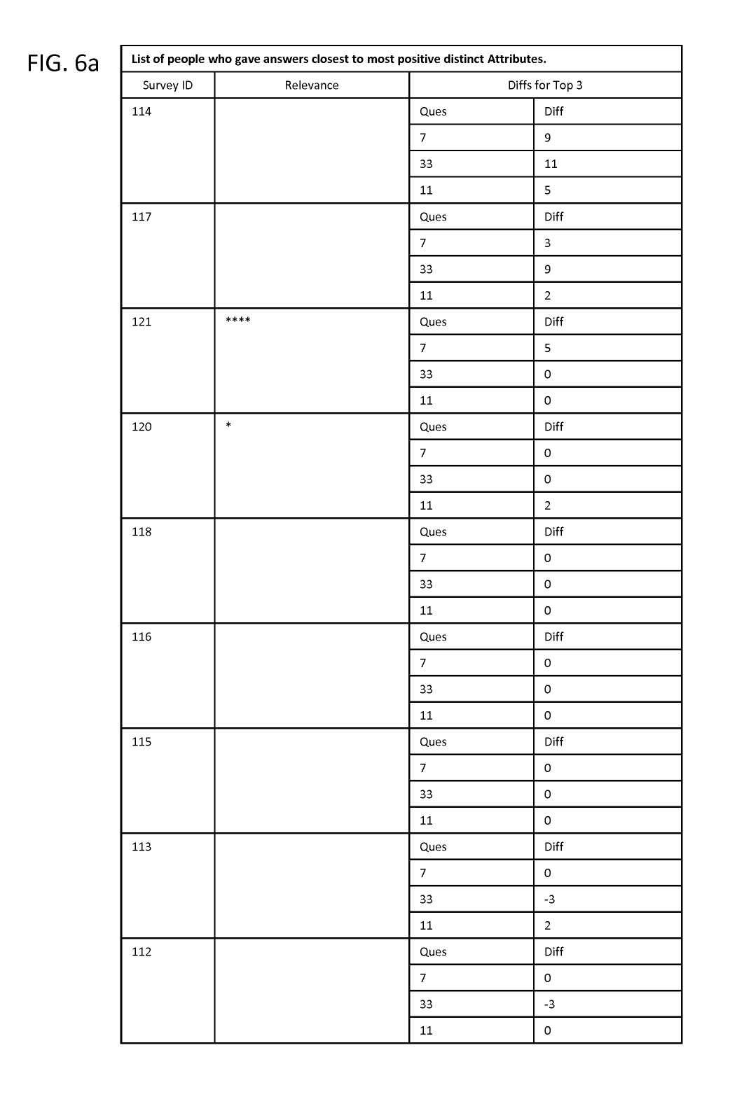

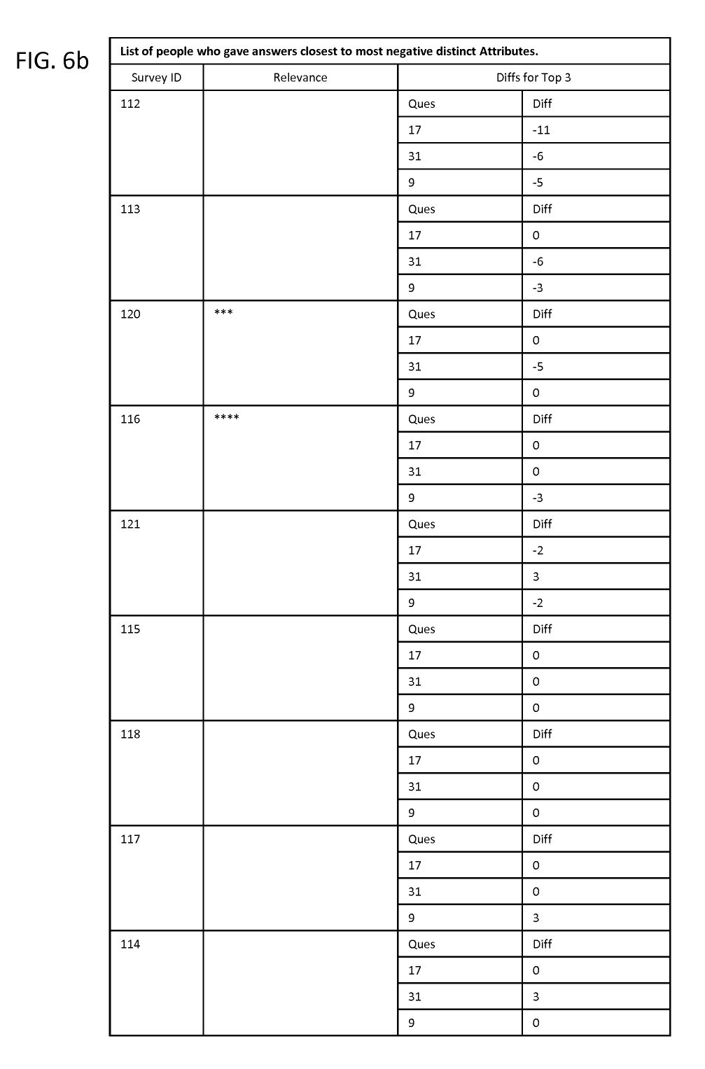

Referencing the numerical weights from FIG. 3, FIG. 6a shows the questions from Part A returning the highest average for positive-values between current job responses and previous job responses for several respondents, where questions seven, thirty three, and eleven give average differences in use of Attributes as being 2.333, 2.222, and 1.889 respectively. FIG. 6b shows the questions from Part A returning the lowest negative-value differences between current job responses and previous job responses for several respondents, where questions thirty-one, seventeen, and nine, give average differences in use of Attributes as being −1.667, −1.000, and −0.778 respectively. Because questions in Part A are a pretext, these six questions reflect the most distinctive Attributes for the subject organization, being Hierarchy, Structure, Autonomy, Innovation, Ambition, and Collaboration.

The program can be defined with the following pseudo code to extract questions returning, on average, the highest weighted response choices and the lowest weighted response choices for the current job against the previous job across a number of respondents. The program of the present invention uses scripting languages including but not limited to PHP, SQL, and Javascript programming languages. Below is non-limiting example code implemented in PHP. In the illustrated embodiment, the program can display the most distinct Attributes associated with the questions returning the most noticeable differences in response choices, as displayed in FIG. 6a (most positive returns) and FIG. 6b (most negative returns).

/* The following pseudo code selects answers to quantitative questions with
* greatest positive and greatest negative weighted difference between previous and current
jobs.
* IT presents these questions to the respondent and asks him/her to select one of each and
input a statement at http://cwp.mcfrank.com/statements.php
*/
PositiveQuestions = new Array( ) //array to store questions with greatest positive
difference in weight between previous and current job answers
NegativeQuestions = new Array( ) //array to store questions with greatest negative difference in
weight between previous and current job answers for each QuantitativeQuestions as Question
do {//loop over all quantitative questions in the current survey
Question.Answer.WeightDifference = Question.AnswerCurrentJob.Weight -
Question.Answer.PreviousJob.Weight //calculate difference in weight between the answers for
current and previous jobs
if (Question.Answer.WeightDifference >= 0){//difference is positive or
if (Question.Answer.WeightDifference >
PreviousQuestion.Answer.WeightDifference){
PositiveQuestions.reset( ) //found new greatest positive difference so clear the array
PositiveQuestions.add(Question) //add new question with greatest positive difference to the
array
}
if (Question.WeightDifference = PreviousQuestion.WeightDifference){//questions have same
weight difference
PositiveQuestions.add(Question) //found another question with the same positive difference so
add it to the array
}
}else{ //difference is negative
if (Question.Answer.WeightDifference <= PreviousQuestion.Answer.WeightDifference) {
NegativeQuestions.reset( ) //found new greatest negative difference so clear the array
NegativeQuestions.add(Question) //add new question with greatest negative
difference to the array
}
if (Question.Answer.WeightDifference = PreviousQuestion.Answer.WeightDifference){
//questions have same weight difference
NegativeQuestions.add(Question) //found another question with the same negative
difference so add it to the
}
}
PreviousQuestion = Question //set the previous question to the current
}
if (PositiveQuestions){
print PositiveQuestions //print any questions with equal positive difference and allow the
respondent to choose one and input a statement for the chosen question
}
if (NegativeQuestions){
print NegativeQuestions //print any questions with equal negative difference and allow the
respondent to choose one and input a statement for the chosen question
}

Analysis for Accuracy and Means

FIGS. 6a and 6b are tables having responses to the three questions having the highest positive-value and lowest negative-value differences between average current job responses and average previous job responses, that is, questions seven, thirty-three, and eleven (FIG. 6a) and Questions seventeen, thirty three, and nine (FIG. 6b). Based on these responses, the mean and standard deviation of all of the differences can be computed.

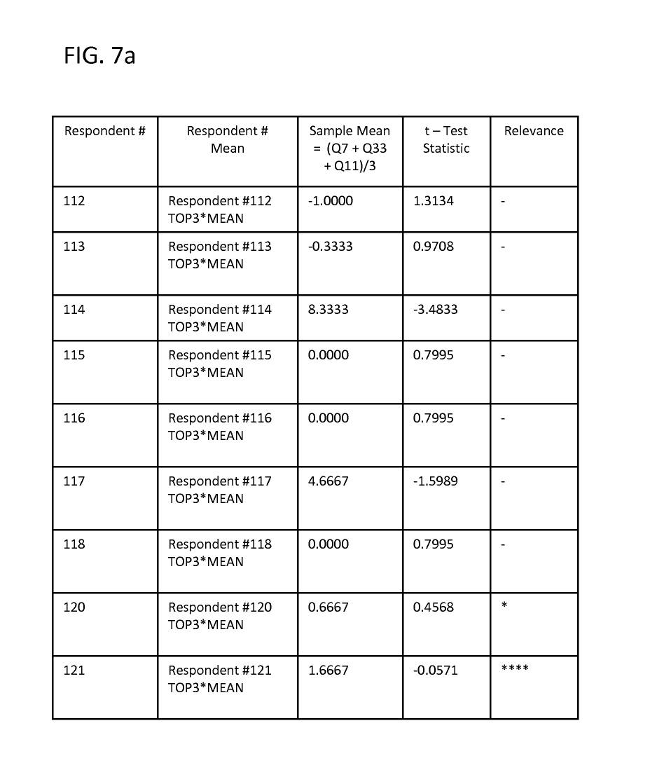

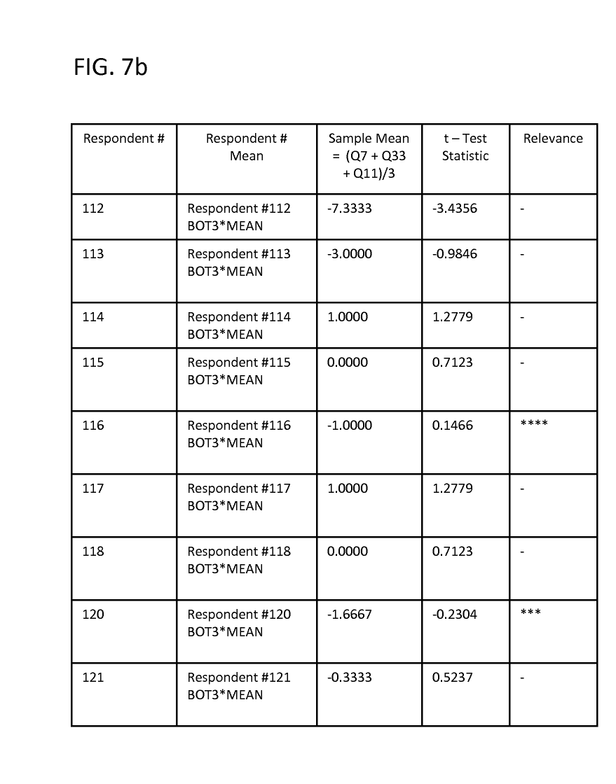

Those skilled in the art will recognize how to compute mean and standard deviation. As shown in FIG. 7a and FIG. 7b, the mean can be referred to as “population top three mean” (FIG. 7a) or as “population bottom three mean” (FIG. 7b), where both can be denoted as μ, and the standard deviation can be denoted as S. Using the responses in FIG. 7a, the population top three mean is approximately μ=1.555556, and the standard deviation is about S=3.370167.

In one embodiment, the program can determine how similar each respondent's choices are to these distinctive characteristics. This similarity is shown in FIG. 6a and FIG. 6b as “relevance,” where a four-star relevance indicates very high similarity and one star indicates moderate similarity, and so on for two and three stars. Relevance/similarity can be computed in many different ways that will be known to those skilled in the art. One way to compute relevance is using t-test statistics, as described below.

t=X−μ/Sₓ

where X denotes the mean of the particular respondent's choices to the three questions in either FIG. 6a or FIG. 6b. Using the example from FIG. 6a, X=(Q7+Q33+Q11)/3, which is shown for each respondent, where the same can be solved for data in FIG. 6b.

In one aspect of the disclosed invention, a particular respondent's similarity/relevance is determined based on the value of the t-test statistic. In one embodiment, the relevance star rating can be determined based on the absolute value of the t-test statistic as follows in TABLE 4.

TABLE 4
|t-test statistic| Within Range

| | ≧0.0, ≦0.2 | ≧0.2, ≦0.3 | ≧0.3, ≦0.4 | ≧0.4, ≦0.5 | >0.5 |
|---|---|---|---|---|---|
| Rele- | **** | *** | ** | * | — |
| vance | | | | | |

Using the standard deviation and the number of questions (denoted as n), a standard error of respondent sample mean Sₓ can be computed as:

Sₓ=s÷\sqrt{n}

For FIG. 7a, the number of questions is n=3. Thus, Sₓ=3.370167÷\sqrt{3}, which is about Sₓ=1.945767.

FIG. 6b show the respondent data and similarity computations for the three questions having the most negative-valued differences, that is, questions seventeen, thirty-one, and nine. As shown in FIG. 7b, the population bottom three mean is approximately μ=−1.25926 and the standard deviation is about S=3.062226.

In various embodiments, the analysis and computations in FIGS. 6a-7b need not be limited to three highest positive-value differences and three lowest negative-value differences, and another number of questions can be used. For example, in other embodiments, the top three (or another number of) absolute-value differences can be selected. Additionally, the similarity computations above are exemplary and do not limit the scope of the disclosed invention. Other similarity computations and statistical metrics are contemplated to fall within the scope of the disclosed invention.

Part B: Respondent Exposition on Attributes

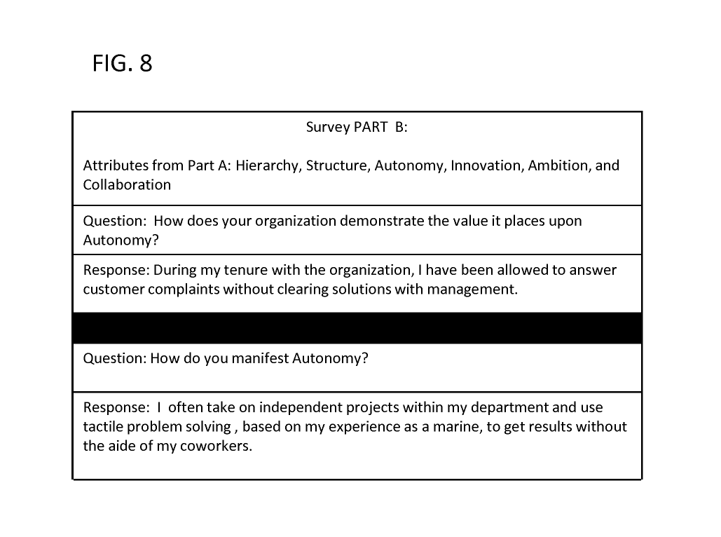

The purpose of Part A is to have the respondent generate distinctions in the use of Attributes in the current job against a similar job at a previous organization via pretexted questions. However, these Attributes valued by the organization are hidden from the respondent in Part A. However, in Part B the pretext is removed and the Attributes returning the greatest distinctions on either side of the curve are revealed. Part B asks the respondent introspective questions about their use of these and more personal Attributes they find essential to their current job. FIG. 8 shows an entry field where these questions are presented to the respondent to gain their insight on how an organization values an Attribute from Part A. Seeing the Attributes without the pretext allows the respondent to let their work experience with the current organization help define their understanding of how the organization defines and values these Attributes in comparison to their work experience with a previous organization.

Table 6 discloses non-limiting opened ended questions for Part B.

TABLE 6
Different companies can place different values on specific Attributes.
Which Attribute do you find is valued more highly here than at the last company you worked for?
And why do you think this Attribute was less valued in your previous job?
Work environments appear similar from the outside. Look beneath the surface and many vital differences are revealed.
What is it about the values, ideas and outlook of your present work environment that differentiate it from others you have
experienced?
Looking at your department as a group, rather than individually, what Attributes do you think are most highly-valued across
the whole team?
Different companies can place different values on specific Attributes.
Which Attribute quality do you find is valued more highly here than at the last company you worked for?
And why do you think this Attribute was less valued in your previous job?
Why do you think the Attribute you mentioned was more valued in your current job?
Your job requires a range of Attributes daily.
Which of your Attributes do you feel is the most called upon, to perform your job well?
And what is it about your current working environment that allows you to apply that particular Attribute to the fullest?
What key Attribute do you utilize on a day to day basis in order to perform your job well?
How do you apply that attribute?
What type of Attributes would thrive under your current department management?
What Attributes has more value here and less where you worked before?
How and why were these Attributes less valued in your previous job?
Give Example?
What Attribute do you value most about yourself that you get to utilize here?
What is the biggest obstacle you have in doing your job effectively?
How would you best describe the values, ideas and purpose in your work environment?
What do you do differently here than what you did elsewhere?
How is your role different here than doing this job elsewhere?
What quality is more valued here and less where you worked previously?
How and why was this quality less valued in your previous job?
Your job requires a range of talents daily. Which of your talents do you feel is the most called upon, to perform your job
well?
And what is it about your current working environment that allows you to apply that particular talent to the fullest?
What is the Attribute that you highly value in yourself that's allowed to be exercised here in your current job?
What is the Attribute you value most in yourself that caused you trouble in your previous company and does not cause you
trouble at all or to the same degree here?
How does your Organization demonstrate the value it places on any of the Attributes selected from Part A?
How do you manifest any of the Attributes selected from Part A?

The Insight Report

Data gathered from survey Parts A and B are aggregated and analyzed to create an insight report that provides the organization with a number of key insights into its job distinctions. Analysis of data and information returned for Parts A and B can be done by an industrial organization psychologist. The report is a psychological snap shot of unique Attributes that are valued by the organization and employees that completed the survey, which can be used to create advertising scripts.

The psychologist analyzes and transforms data from Parts A and B to find language from both the organization's and the employee's perspective to create an insight report that gives the organization intel on key job distinctions including but not limited to: distinctions in the use of Attributes in the current job against a similar job with the previous organization, an Attribute the employee values in themselves [The Unarticulated Hero], how an employee uses Attributes favored by the current organization, how distinctions in the use of Attributes vary across jobs and workgourps, which types of employees use which Attributes, and the like. The psychologist's analysis found in the report is also used as a language guide for advertising script writers when creating job postings to attract “right fit candidates”.

A non-limiting example of how an industrial organization psychologist may analyze data for FIG. 3 may begin with the most positively-valued difference, being question/Attribute seven. This may signify that, at the subject organization, it is more acceptable to bypass the established chain of command to solve a problem more efficiently, as compared to other employers. The organization's valuation of this Attribute, the unseen Hierarchy, may signify that the organization may be more suitable for “go getters” who have less regard for a chain of command.

The psychologist's analysis may continue with FIG. 3, the most negatively-valued difference is associated with question/characteristic thirty-one. This may signify that at the subject organization, fewer opportunities exist to participate in management and decision-making, as compared to other employers. The organization's valuation of this Attribute, the unseen Collaboration, may signify that the subject organization may be more suitable for employees who are content being workers rather than managers.

The psychologist may place together Attributes seven and thirty-one to suggest that the subject organization may be more suitable for job seekers who are fine with being workers rather than managers, and who are comfortable bypassing the chain of command to finish the work more efficiently. Questions seven and thirty-one are used simply as examples, and other Attributes, hidden form the respondent in Part A, shown in FIG. 3, may also signify distinctive Attributes valued by the subject organization. In one embodiment, the average response values and difference values shown in FIG. 3 can be stored in an information database (103, FIG. 1).

The program shows the Attributes to the respondent in Part B, where exposition is required (see FIG. 8). Keys words are selected from the respondent's exposition to give the organization insights on how and why the employee uses certain Attributes more at the current job than in the previous job at another organization, or vice versa. Non-limiting example being, from part B, language used to answer the question, “What Attribute are you using that was stifled at the previous organization?” The answer is analyzed to get the respondent's perspective of an Attribute that was not appreciated or valued at a previous organization.

The report presents insights that include, without limitation: a Unique Recruitment Proposition, insight into Hidden Motivators, insight into Job Differentiators, insight into the Employee's Valued Attribute, insight into the Organization's Job Quotient, and insight into the Organizational Quotient.

The Unique Recruitment Proposition

The Unique Recruitment Proposition asks “What Attributes & skills are more valued here?” In Part A, the respondent unknowingly selects Attributes through pretexted questions giving the largest numerical difference against all data values. Theses Attribute may be presented in question form for this insight.

The Hidden Motivators

The Hidden Motivators is an insight created from the respondent's answer to the question “What is one unspoken thing about this workplace?” This answer is analyzed for language that describes hidden Attributes that might be missing from the organization's list of valued Attributes in Part A.

The Employee's Valued Attribute

The Employee's Valued Attribute is an insight created from the respondent's answer to the question “What is an Attribute you most value in yourself that is allowed to be exercised in your current job?” This answer inherently gives Attributes to attract “right fit” applicant that exhibit this quality in abundance and is proud to possess. It's a special quality one feels would provide a real advantage in the right work environment when valued and allowed to be exercised by an organization.

The Job Differentiators

The Job Differentiators is an insight created through the analysis of numerical differences to the pretexted questions of Part A. Answers that give the greatest difference for their use of an Attribute at the current job and use at the previous job are reported. Having these numbers shows an organization's key job distinctions against its competitors.

The Job and Organizational Quotient

The Job and Organizational Quotients are summations of data and language that gives a quantitative description of what is distinctive about a specific job and a quantitative aggregation of the common distinctions of all the jobs surveyed in an organization.

The present invention also includes a computing system that generates an insight report for finding distinctions in the use of Attributes valued by an organization or an employee to crate advertising scripts. The systems includes without limitation: one computer readable medium having a plurality of Attributes valued by an organization, a plurality of data regarding Attributes in relation to a first organization against a relation to other organizations, and program for taking differences, means, and, standard deviations to analyze distinctions between numerical weights on response choices between a current organization against a previous organization, and entry GUIs to allow a respondent to give exposition on hidden Attributes, Attributes valued by the organization, and Attributes they personally value.

What have been described above herein are computing systems and methods for gathering, analyzing, and presenting information to statistically characterize an organization's valuation of Attributes. It will be understood that these examples do not limit the spirit and scope of the disclosed invention. It is contemplated that the various embodiments disclosed herein are not exclusive and can be combined in different ways to provide the technology disclosed herein.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I claim:

1. A method for creating an insight report to generate advertising scripts and measure job distinctions within an organization comprising the steps of:
a. administering a two part survey to a respondent, Parts A and B, that measure and describe distinct Attributes used in their current job against a similar job held with a previous employer;
b. wherein each question for Part A is a pretext to measure the use of distinctive Attributes in a job within the current organization;
c. where the respondent answers each question with a weighted response choice, once for the current organization and again for the previous organization;
d. where the program takes differences between the weighted response choices;
e. the program reveals the Attributes with the greatest distinction on either side of the curve selected from Part A to the respondent;
f. wherein Part B the respondent answers a series of open ended questions regarding the Attributes selected in Part A and personal Attributes used at both the current job and previous job; and
g. wherein the data from Part A and Part B are aggregated and analyzed into an insight report that finds language for eventual advertising scripts and provides the organization with distinctions in their jobs over other organizations.

2. The method of claim 1, wherein the respondent has been resident in a job with a current organization for at least four months and has held a similar position with a previous employer.

3. The method of claim 1, wherein a distinct Attribute is a numerical difference between weights on pretexted questions that measures an employee's use of an Attribute in a current job against a similar job held with a previous employer.

4. The method of claim 1, wherein Attributes refer to unspoken qualities or characteristics that the organization values, recognizes, and rewards or that the respondent personally uses during the course of their work day to do their job, or any combinations thereof.

5. The method of claim 1, wherein the insight report is an aggregation on the distinctions for Attributes selected from Part A or at least one personal Attribute from respondent in Part B with exposition on the use and importance of the same, or any combinations thereof.

6. The insight report of claim 1, wherein the report includes a Job Quotient, Organizational Quotient, Job Differentiators, The Employee's Valued Attribute, and The Unique Recruitment Proposition, which divulge to an organization key distinctions in the use of Attributes in the current job with the current organization, key distinctions in the use of Attributes in the previous job with the previous organization, an Attribute the employee values in themselves, how an employee's uses Attributes favored by the current organization, how distinctions in the use of Attributes vary across jobs and workgourps, and which types of employees use which Attributes.

7. A computing system that generates an insight report for finding distinctions in the use of Attributes valued by an organization against a previous organization or an employee to create advertising scripts comprising:
a. one computer readable medium having a plurality of Attributes valued by an organization,
b. a plurality of data regarding Attributes in relation to a first organization against a relation to other organizations, and
c. program for taking differences, means, and, standard deviations to analyze distinctions between numerical weights on response choices between a current organization against a previous organization, and
d. entry GUIs to allow a respondent to give exposition on hidden Attributes, Attributes valued by the organization, and Attributes they personally value.

8. The method of claim 1, wherein an industrial organization psychologist analyzes the results of Parts A and B to find language that creates the insight report.
